(19) United States
(12) Patent Application Publication
(10) Pub. No.: US 2024/0376930 A1
(43) Pub. Date: Nov. 14, 2024

(54) MAGNETIC BEARING DEVICE

(71) Applicant: PHYSIK INSTRUMENTE (PI) GMBH & CO. KG, Karlsruhe (DE)

(72) Inventor: Alexander GOOS, Ettlingen (DE)

(21) Appl. No.: 18/287,448

(22) PCT Filed: Apr. 25, 2022
(86) PCT No.: PCT/EP2022/060822

§ 371 Date: Oct. 18, 2023

(30) Foreign Application Priority Data
Apr. 23, 2021 (DE) 10 2021 110 415.7

(51) Int. Cl. F16C 32/04

(52) U.S. Cl. CPC F16C 32/0465; F16C 32/0472

(57) ABSTRACT

A magnetic bearing device is provided and includes a stator arrangement having at least two stators and a rotor, wherein the stator comprises a coil apparatus having at least one coil former, magnets and a flux conducting device, the rotor is movable relative to the stator arrangement along a longitudinal direction of the stator arrangement, and the stator arrangement and the rotor are configured such that when electrical energy is applied to the coil apparatus, a magnetic force can be applied to the rotor to form an air gap between the stator arrangement and the rotor. Thereby, the smallest distance between the flux conducting devices of the at least two stators in the longitudinal direction of the stator arrangement is in a range between zero and the distance between the coil apparatuses of the at least two stators. A positioning system comprising such a magnetic bearing device is also provided.

### CROSS REFERENCE TO RELATED APPLICATIONS

This application is a U.S. National Phase Application under 35 U.S.C. 371 of International Application No. PCT/EP2022/060822, filed on Apr. 25, 2022, which claims priority to German Patent Application No. 10 2021 110 415.7, filed on Apr. 23, 2021. The entire disclosures of the above applications are expressly incorporated by reference herein.

### TECHNICAL FIELD

The present invention relates to a magnetic bearing device comprising a stator arrangement having at least one stator and a rotor, wherein the stator having a coil apparatus with at least one coil former, magnets and a flux conducting device, the rotor is movable relative to the stator arrangement along at least a longitudinal direction of the stator arrangement, and the stator arrangement and the rotor are configured such that a magnetic force can be applied to the rotor to form an air gap between the stator arrangement and the rotor, when electrical energy is applied to the coil apparatus. Furthermore, the present invention relates to a positioning system having such a magnetic bearing device.

### BACKGROUND

Such magnetic bearing assemblies and corresponding positioning systems are known in the prior art for precise positioning of position-critical devices. Generic positioning systems with a magnetic bearing device are known from first publication “Design of Novel Permanent Magnet Biased Linear Magnetic Bearing and it's Application to High-Precision Linear Motion Stage”, Sang-Ho Lee et al. and second publication “The High Precision Linear Motion Table With a Novel Rare Earth Permanent Magnet Biased Magnetic Bearing Suspension”, Dong-Chul Han et al.

The first publication describes a magnetic bearing device comprising a stator and a slider movable relative to the stator along a direction of motion. The magnetic bearing device is essentially composed of flux conducting components, magnets, and coils, and is configured to exert a magnetic force on the rotor to fully compensate for the weight force of the rotor, thereby acting as a lifting force on the rotor, when electrical energy is applied to the coils. In particular, the current-carrying coils generate a magnetic field that interacts with the magnetic field generated by the magnets. The active elements (coils) are located in the rotor, which has the disadvantage that the cables required for the electrical power supply must be attached to the rotor and carried along when the rotor moves relative to the stator. Alternatively, wireless power transmission would have to be provided or energy storage elements would have to be arranged in the rotor, which would result in a significant increase in rotor weight. Furthermore, with this configuration, dissipation of the electrically induced heat input is only possible via air and possibly via cables.

The second publication describes an xy-table, which also includes part of the structure of the magnetic bearing device from the first publication. However, here the active elements (coils) are part of the stator, which means that the electrical energy no longer has to be supplied to the rotor. However, a much smaller travel distance and change of the force application points with respect to the rotor coordinate system during the movement of the rotor are the disadvantages of this configuration. In particular, the position of the force application points are dependent on the geometric dimensions, resulting in position-dependent lever arms with respect to a torque, which is disadvantageous for the control of such a system and further leads to a position-dependent power requirement along the direction of motion.

In addition, there are novel magnetic bearing assemblies with a stator and a rotor, in which the coils and the magnets as well as an associated flux conducting device are provided exclusively in the stator and in which impressing of electrical energy to the coils imposes a magnetic force on the rotor, which forms an air gap between the stator and the rotor. In this case, the extension of the rotor in the longitudinal direction is as small as possible to allow the longest possible travel along the stator. For longer travel distances, it is necessary to make the rotor as short as possible compared to the stator arrangement, since longer stator assemblies of coils, magnets and flux conducting devices lead to high power losses and poorer motor efficiency.

### Summary

The present invention is therefore based on the task of providing a magnetic bearing device allowing long travels of the rotor in its direction of longitudinal extension of the stator with just low power dissipation.

This task is solved in a generic magnetic bearing device in particular by the fact that the stator arrangement has at least two stators, wherein the smallest distance between the flux conducting devices of the at least two stators in the longitudinal direction of the stator arrangement being in a range between zero and the distance between the coil apparatuses of the at least two stators, preferably between zero and 50% of the distance between the coil apparatuses, in particular between zero and 10% of the distance between the coil apparatuses. In this case, the coil apparatuses are provided exclusively in the stators of the stator arrangement, which means that no electrical energy has to be transmitted to the rotor and that the rotor, as a passive assembly, can be reduced to a minimum in terms of its dimensions and weight. As a result, the rotor can be moved along the stator during active control without significant cogging forces and cogging torques. For longer travels of the rotor in the longitudinal direction of the stator arrangement or in the direction of movement of the rotor along the stator arrangement, the present invention provides a stator arrangement with at least two stators, wherein the flux conducting devices of the at least two stators extend almost continuously in the longitudinal direction along the stator arrangement. Compared to a stator arrangement with a very long stator, the arrangement of at least two stators enables significantly lower power losses as well as better efficiency, since the usable part of the coils is determined by the length of the conclusions. Furthermore, the provision of several short stators enables manufacturing advantages, since several identical parts can be used instead of complexly produced individual components. In order to minimize the cogging forces and cogging torques occurring during the transfer of the rotor between the at least two stators as well as force holes in the carrying direction due to the interruption of the flux conducting device at the pole faces of the coils, the smallest possible distance between the flux conducting devices of the at least two stators is provided so that the stators can be designed with flux conducting material almost continuously in the longitudinal direction. Accordingly, a type of rail is created along the longitudinal direction of the at least two or more stators of the stator arrangement so that the magnetic flux is distributed reasonably homogeneously over the entire area of the flux conducting device of the stator arrangement. When using several stators, the individual areas of the stator arrangement can be controlled individually, so that, compared to a single stator with a corresponding length, a significantly smaller power loss is possible with the magnetic bearing device according to the present invention, since only relevant stators need to be energized.

A preferred embodiment provides that the flux conducting devices of the at least two stators contact each other in the longitudinal direction of the stator arrangement or are in direct contact with each other. The direct contact or the material connection of the flux conducting devices at the respective pole faces minimizes the occurrence of force holes in the carrying direction during the transition between the stators of the stator arrangement.

A convenient embodiment provides that the flux conducting devices of the at least two stators comprise flux conducting bars, the flux conducting bars protruding at least partially with respect to the upper or lower end surfaces of the coil apparatus of the at least two stators. The provision of flux conducting bars facilitates the formation of substantially continuous flux conducting devices of the stator arrangement, thereby avoiding the occurrence of large cogging forces and cogging moments. The flux conducting bars are preferably provided in the area of the exit and entry points of the magnetic flux in order to achieve the most possible homogeneous distribution of the magnetic flux.

An expedient design of the stator arrangement provides that the flux conducting devices of the at least two stators have flux conducting components, the flux conducting bars being configured integrally with the flux conducting components. In this way, the stators of the stator arrangement can be designed with flux conducting devices of the same type, so that for a stator arrangement the stators can easily be combined in any number.

In another embodiment, the flux conducting devices of the at least two stators include flux conducting components, wherein the flux conducting bars are configured separately from the flux conducting components and are in contact with the flux conducting components, whereby different materials and geometries can be used for the flux conducting bars. For example, the flux conducting bars can be configured in a trapezoidal shape for homogeneous force distribution. In this context, it is advantageous if the flux conducting bars extend in one piece over at least two stators, so that there is no minimum distance between the flux conducting devices of the at least two stators of the stator arrangement and an uninterrupted magnetic flux is enabled between the at least two stators.

In one advantageous embodiment, the rotor includes at least two rotor flux conducting components disposed on opposite sides of the stator arrangement and interconnected by an at least partially non-magnetic member. By this construction, the rotor embraces the stator arrangement in a very compact design. In this context, it is advantageous that the connecting element is made of a non-magnetizable material in order to realize the most compact design possible.

A particular embodiment provides that the at least two rotor flux conducting components extend in the longitudinal direction of the stator arrangement over at least one stator of the stator arrangement. Thus, the rotor is longer than one stator and accordingly permanently covers at least two stators at least partially. This enables a more uniform movement of the rotor along the stator arrangement.

An alternative embodiment provides that the at least two rotor flux conducting components are shorter in the longitudinal direction of the stator arrangement than a stator of the stator arrangement. In this way, the rotor always covers a maximum of only one stator transition and, in the case of a multi-part stator arrangement, a maximum of two stators have to be supplied with electrical energy, which can lead to an overall lower power loss.

Advantageously, each coil former can extend in its own plane, and preferably the length of the magnets and flux conducting components of the stator in the longitudinal direction corresponds to the length of the parallel sections of each coil former. By having substantially the same length of the magnets, flux conducting components, and parallel sections of the coil former, a homogeneous region can be created that allows for a high degree of uniformity with respect to the motion of the rotor.

In an additional variant, the magnets in the stator of the stator arrangement can each be arranged between two flux conducting components of the flux conducting device. This arrangement prevents demagnetization of the magnets by the magnetic field generated by the coil apparatus.

In addition, it may prove useful if the coil apparatus has coil former arranged one above the other and the magnets are arranged in a plane between the coil former. In this case, each coil former extends in its own plane parallel to the flux conducting components of the rotors. By this arrangement of the magnets, magnetic fields can be generated which specifically act together or specifically act against each other. Preferably, the lengths of the magnets and the flux conducting components in the longitudinal direction correspond to the length of the parallel sections of each coil former.

Further, it may be convenient for a magnetic bearing device if each coil former is arranged between two parallel extending flux conducting components of the flux conducting device, which preferably extend in the longitudinal direction of the stator arrangement, wherein in particular at least one of said flux conducting components comprises a coupling portion by means of which it can be coupled to a further structure, preferably a housing. In this construction, the flux conducting component not only conducts the magnetic flux, but also simultaneously serves as a component for attaching the stator arrangement to a housing.

In a useful modification, the flux conducting device in the stator of the stator arrangement includes a central flux conducting component having a cross-shaped cross-section, wherein opposing portions of the central flux conducting component are disposed in the openings of different coil former. This configuration allows the magnetic flux to be directed in a targeted manner while maintaining a compact design. However, other cross-sections for the central flux conducting component are also conceivable, such as those with a plate-shaped geometry, which have the advantage of significantly reduced manufacturing costs for such a central flux conducting component.

Furthermore, it can be an advantage if the magnets and/or the flux conducting components are configured in one piece or in several pieces. Depending on the structure of the stator arrangement, magnets and flux conducting components configured in one piece or in multiple pieces can reduce the effort required to assemble the magnetic bearing device.

Further, the present invention relates to a positioning system comprising a housing, a platform and at least one of the magnetic bearing device described above, wherein the stator arrangement of the magnetic bearing device is coupled to the housing and the platform is coupled to the rotor. With such a positioning system, it is possible to move the platform relative to the housing or the stator over a longer distance in the longitudinal direction of the stator arrangement without having to overcome major cogging forces or cogging torque and without having to compensate for major force holes in the bearing direction between the individual stators of the stator arrangement. Advantageously, the positioning system may include a linear motor that moves relative to the housing in the longitudinal direction of the stator arrangement. High-precision positioning of the platform can be achieved via selection of the control parameters of the linear motor as well as of the magnetic bearing device.

A coil apparatus in the sense of the present invention comprises, in the simplest case, a coil former whose windings extend concentrically and in a common plane, and also comprises, in addition, a coil former whose concentric windings extend in several different planes. Here, the turns of the coil former can be embedded in an insulating material, for example an epoxy resin. Further, it is conceivable to electrically connect individual coil former of the coil apparatus in parallel or in series. Furthermore, non-magnetic materials include both non-magnetizable and very weakly or non-permanently magnetizable materials, but in particular materials with permanent magnetic or ferromagnetic properties are excluded.

### BRIEF DESCRIPTION OF THE DRAWINGS

In the following, non-limiting embodiments of the invention are explained in more detail with reference to exemplary drawings.

FIG. 1 is a perspective view of a stator of a magnetic bearing device according to the invention,

FIG. 2 is a sectional perspective view of the stator of FIG. 1,

FIG. 3 is a perspective view of a stator arrangement for a magnetic bearing device according to the invention,

FIG. 4A is a perspective view of a magnetic bearing device according to the invention with the stator arrangement of FIG. 3 and a short rotor,

FIG. 4B is a perspective view of a magnetic bearing device according to the invention with the stator arrangement from FIG. 3 and a long rotor,

FIG. 5 is a perspective view of another embodiment of a magnetic bearing device according to the invention,

FIG. 6A is a perspective view of a stator arrangement for a magnetic bearing device according to the invention,

FIG. 6B is a perspective view of another embodiment of a magnetic bearing device according to the invention with the stator arrangement of FIG. 6A,

FIG. 6C is a perspective view of the magnetic bearing device according to the invention from FIG. 6B with a different flux conducting device,

FIG. 7A is a partially exposed view of the magnetic bearing device of FIG. 6C with short one-piece magnets,

FIG. 7B is a partially exposed perspective view of the magnetic bearing device of FIG. 6C with multi-part magnets,

FIG. 7C is a partially exposed perspective view of the magnetic bearing device of FIG. 6C with long one-piece magnets,

FIG. 8 is a perspective view of a positioning system according to the invention,

FIG. 9 is a perspective view of the positioning system of FIG. 8, where the platform is not shown for illustration, and

FIG. 10 is a perspective view of the positioning system of FIG. 8, wherein the housing as well as the stators are not shown for illustration.

### DETAILED DESCRIPTION

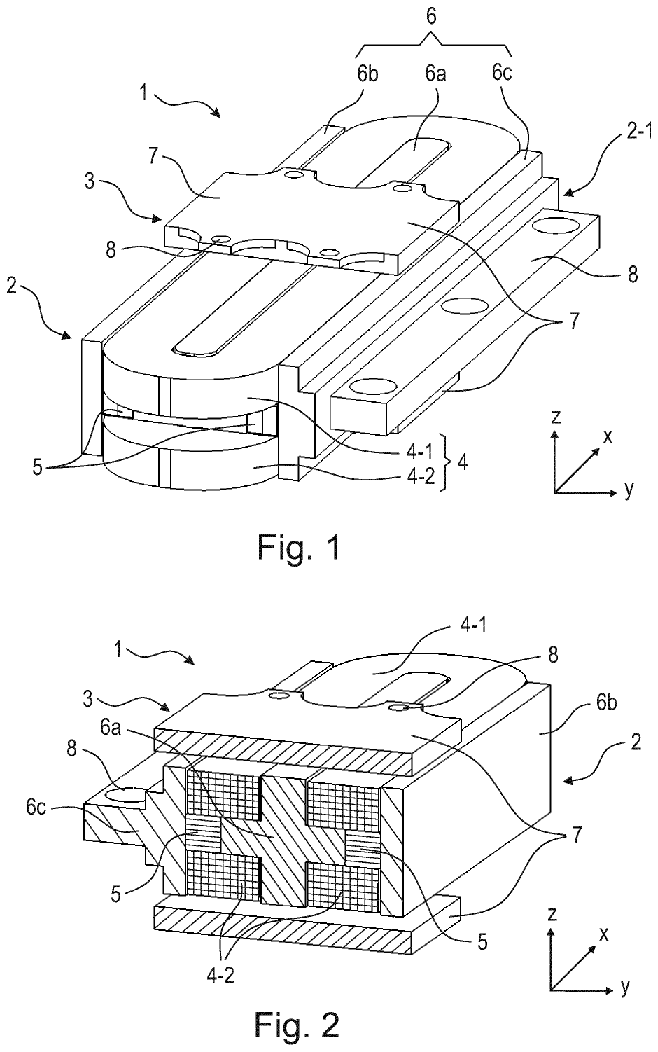

Based on the perspective view of a single stator 2-1 of the stator arrangement 2 of a magnetic bearing device 1 shown in FIG. 1, the mode of operation of the magnetic bearing device 1 is explained in more detail. The magnetic bearing device 1 comprises a stator arrangement 2 with at least two stators 2-1, 2-2 and a rotor 3, wherein FIG. 1 shows only one stator 2-1.

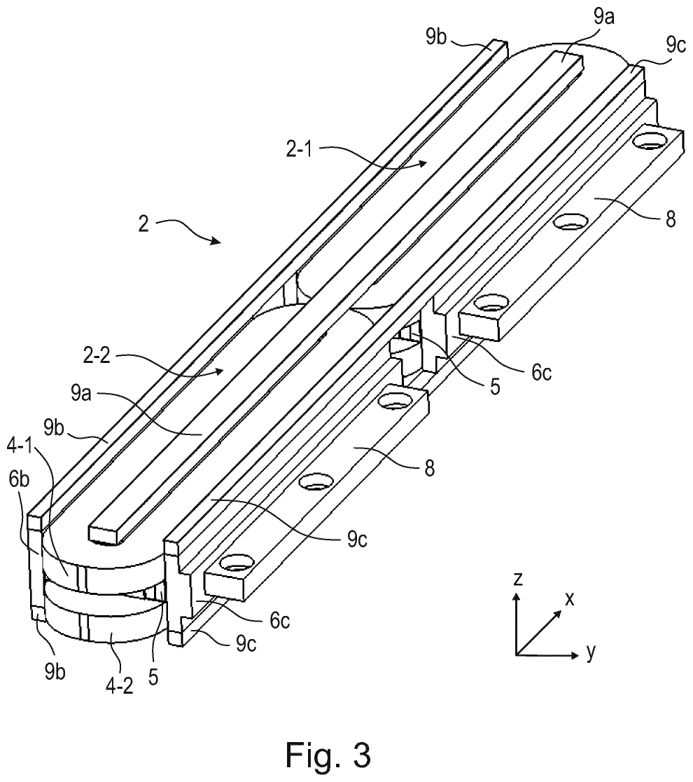

The single stator 2-1 of a magnetic bearing device 1 according to the invention comprises a coil apparatus 4 with two separate and electrically interconnected coil former 4-1, 4-2, which are arranged one above the other in the z-direction and consequently in parallel xy-planes. It is equally conceivable not to connect the coil former electrically to each other. The length of the coil former 4-1, 4-2 extends in the x-direction. The stator 2 1 further comprises a flux conducting device 6 having three flux conducting components 6a, 6b, 6c made of a magnetizable steel and four magnets 5, wherein only two magnets 5 are visible at the end face of the stator 2-1. The magnets 5 also extend in the x-direction. As can be clearly seen in the sectional view of the stator 2-1 in FIG. 2, the two outer flux conducting components 6b, 6c flank the coil former 4-1, 4-2 of the coil apparatus 4, so that they are located between the two outer flux conducting components 6b, 6c in the y-direction. The third flux conducting component 6a is arranged as a central flux conducting component 6a in the y-direction between the outer flux conducting components 6b, 6c and in the z-direction between the coil former 4-1, 4-2. In the present embodiment, the central flux conducting component 6a has a cross-shaped cross-section and thus engages with vertically opposite sections in the openings of the coil former 4-1, 4-2. Furthermore, one of the outer flux conducting components 6c is provided with a coupling section 8 which extends along the outer flux conducting component 6c in the x-direction and enables a connection to another structure, in particular to a housing 12 of a positioning system 11. Two magnets 5 each are arranged between an outer flux conducting component 6b, 6c and the central flux conducting component 6a in the y-direction and between the coil former 4-1 and 4-2 in the z-direction. In this embodiment, the height of the flux conducting components 6a, 6b, 6c in the z-direction is designed, so that the flux conducting components 6a, 6b, 6c are flush with the upper and lower end surfaces of the coil former 4-1, 4-2, respectively. As can be seen in the various embodiments of the magnetic bearing device 1 of the present invention, in addition to the flux conducting components 6a, 6b, 6c, the flux conducting device 6 may have flux conducting bars 9a, 9b, 9c, see FIGS. 3 to 7C, which are configured integrally with or separately from the flux conducting components 6a, 6b, 6c and extend along one stator 2-1 or a plurality of stators 2-1, 2-2 of the stator arrangement 2. Thereby, the flux conducting bars 9a, 9b, 9c may protrude with respect to the upper or lower end surfaces of the coil former 4-1, 4-2, which is advantageous for certain applications, such as vacuum applications, in order to conduct the magnetic flux in such a way that magnetic reflux takes place inside the vacuum while the coil former 4-1, 4-2 and magnets 5 are arranged outside the vacuum. In addition, flush closure of the flux conducting bar 9a, 9b, 9c or sawn-off with respect to the end surfaces is also conceivable and advantageous for certain applications.

The rotor 3 of the magnetic bearing device 1 preferably comprises two identical rotor flux conducting components 7 arranged on opposite sides of the stator 2-1, and an at least partially non-magnetic element (not shown) interconnecting the two rotor flux conducting components 7. The rotor 3 is thereby configured to embrace the stator 2-1. The rotor flux conducting components 7 may also have coupling portions 8 that allow connection to another structure, in particular a platform 13 of the positioning system 11. The rotor flux conducting components 7 slightly overhang the stator 2-1, when viewed in the y-direction, resulting in only small restoring forces in the y-direction and allowing reduced power input to the magnetic bearing device 1 for movement of the rotor 3 along the y-direction. Furthermore, the rotor flux conducting components 7 can have a special shape, for example an E-shape, to obtain translational restoring forces in y-direction and rotational restoring forces around the z-axis. In the embodiment of the stator arrangement 2 of a magnetic bearing device 1 shown in FIG. 1 and FIG. 2, the length of the rotor 3 in the x-direction is much smaller than the length of the stator 2-1 in that direction.

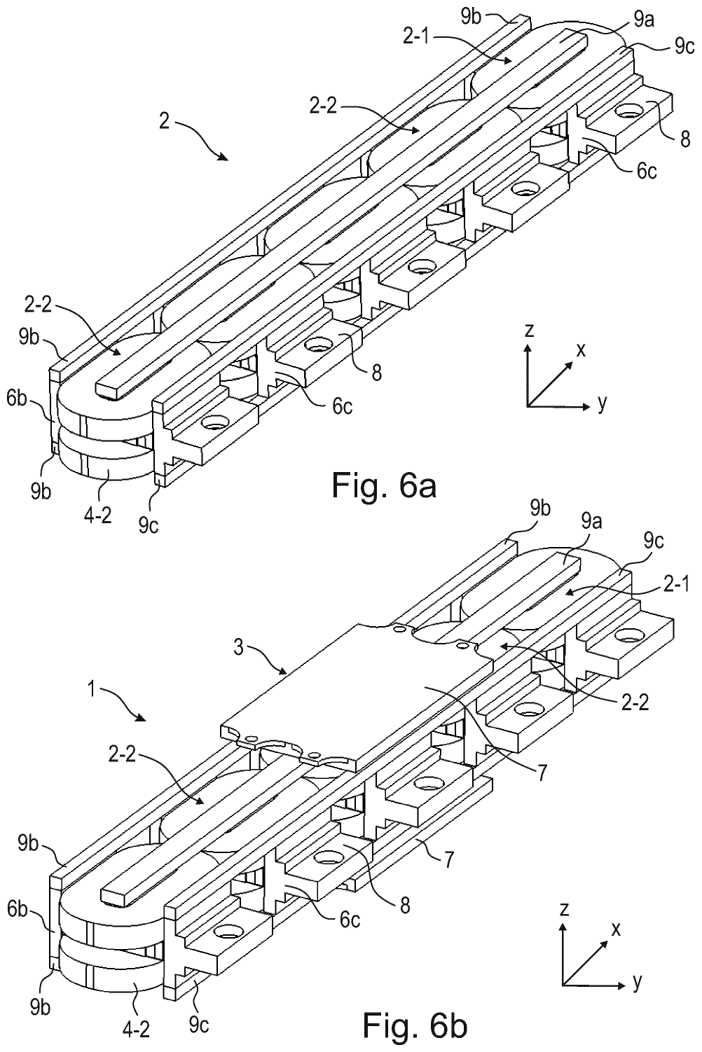

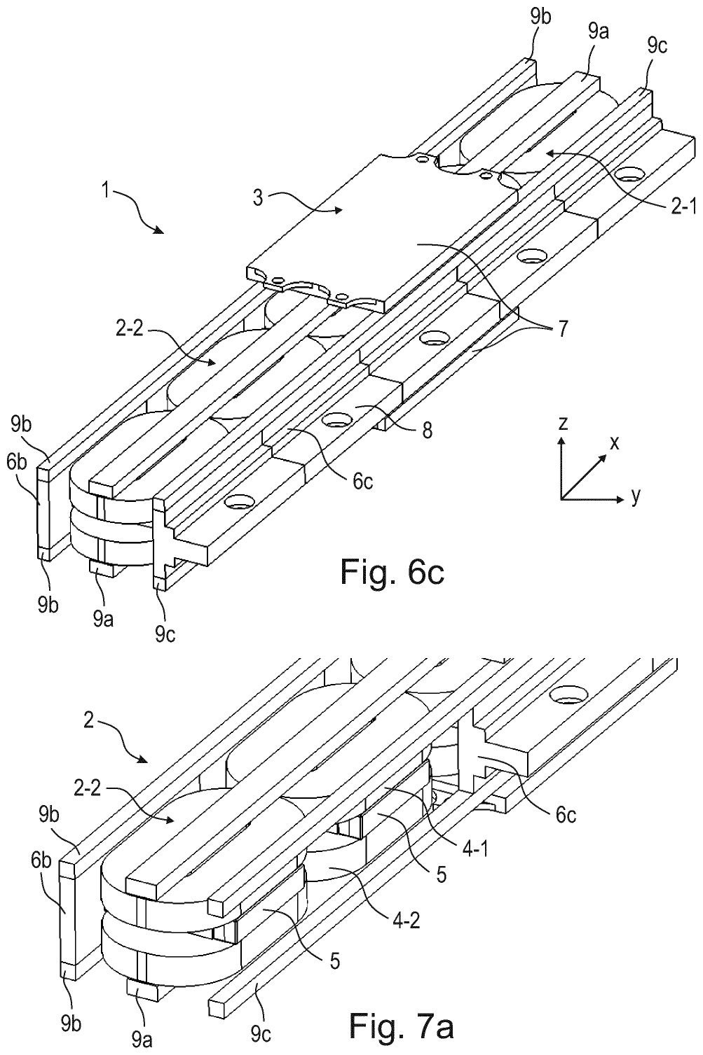

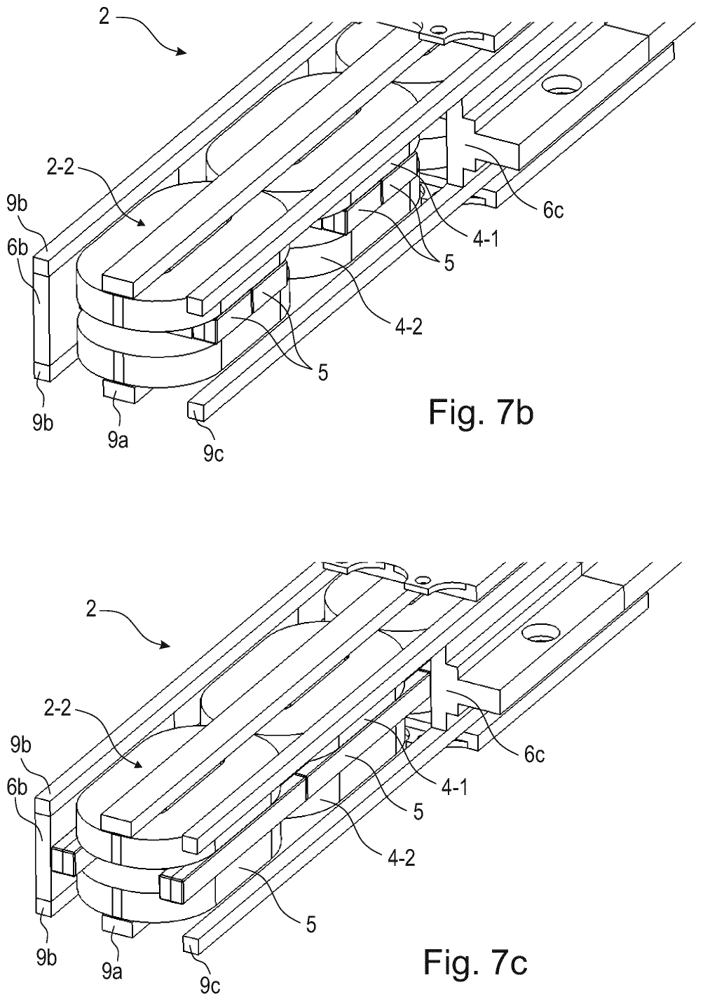

In general, the shapes and structure of the flux conducting device 6 and magnets 5 of the stators 2-1, 2-2 and of the rotor flux conducting components 7 of the rotor 3 are not limited to the numbers, shapes and arrangements illustrated in FIGS. 1 to 7, but can have any expedient shape, in particular also shapes which simplify integration of the stator arrangement 2 and the rotor 3 into higher-level structures, for example into the housing 12 or the platform 13 of the positioning system 11. In this context, in the case of the flux conducting components 6a, 6b, 6c and flux conducting bars 9a, 9b, 9c as well as the rotor flux conducting components 7, it is conceivable to design them in a layered construction or as a laminate construction, with layers of magnetizable material alternating with layers of electrically non-conductive material. The coil former 4 1, 4-2 are preferably wire coils, but foil coils or printed coils can also be used. The magnets 5 of the stators 2-1, 2-2 can be either one-piece or fractional and may extend over different lengths in the x-direction between the coil former 4-1, 4-2, for example over the length of the outer flux conducting components 6b, 6c, see FIG. 6B, or over the entire length of the coil former 4-1, 4-2 or the outer flux conducting bars 9b, 9c, see FIG. 7C.

By applying electrical energy to the coil former 4-1, 4-2, the magnetic bearing device 1 can be directly controlled. The current-carrying coil former 4-1, 4-2 generate corresponding magnetic fields in the flux conducting device 6 of the stator 2-1, i.e. in the flux conducting components 6a, 6b, 6c in FIG. 2, or the flux conducting bars 9a, 9b, 9c, as well as the rotor flux conducting components 7 of the rotor 3, which interact with the magnetic field generated by the magnets 5. These magnetic fields may act with or against each other. If the magnetic field of the upper coil former 4-1 acts against the magnetic field of the magnets 5 in the upper part of the flux conducting components 6a, 6b, 6c, the magnetic field of the lower coil former 4-2 can reinforce the magnetic field of the magnets 5 in the lower part of the flux conducting components 6a, 6b, 6c by the correct selection of the drive (current direction). By selective control, a magnetic lifting force can be applied to the rotor 3, resulting in the formation of an air gap between the upper rotor flux conducting component 7 and the upper surface of the stator 2-1, and between the lower rotor flux conducting component 7 and the lower surface of the stator 2-1. In particular, the size of the air gap, i.e. the distance between the surfaces of the stator 2-1 and the rotor flux conducting components 7 of the rotor 3 in the z-direction, can be adjusted by adjusting the control. This magnetic force acting as a lifting force is thus able to compensate the weight force of the rotor 3 or to position the rotor in the z-direction. With simultaneous stabilization of the rotor 3 with respect to its rotational degrees of freedom about the x-and y-axes, the rotor 3 floats and can be displaced without mechanical friction, i.e. free of external friction, relative to the stator arrangement 2 along the x-direction.

The perspective view in FIG. 3 shows a stator arrangement 2 for a magnetic bearing device 1 according to the invention with at least two stators 2-1, 2-2. Each stator 2 1, 2-2 comprises a coil apparatus 4 with an upper and lower coil former 4-1, 4-2, three flux conducting components 6a, 6b, 6c made of a magnetizable steel, and magnets 5 extending in the x-direction. On one side of the stator arrangement 2, the two outer flux conducting components 6c of the two stators 2-1, 2-2 are provided with coupling sections 8. The flux conducting device 6 of this stator arrangement 2 further comprises flux conducting bars 9a, 9b, 9c extending integrally over the at least two stators 2-1, 2-2 of the stator arrangement 2 in the x-direction parallel to and in contact with the flux conducting components 6a, 6b, 6c. Thereby, the flux conducting bars 9a, 9b, 9c protrude with respect to the upper and lower end surfaces of the coil former 4-1, 4-2, respectively. The flux conducting bars 9a, 9b, 9c extending integrally along the stator arrangement 2 across the two stators 2-1, 2-2 in order to connect the individual flux conducting components 6a, 6b, 6c of the stators 2-1, 2-2 to form a common flux conducting device 6, so that the magnetic flux can be distributed reasonably homogeneously over the entire area of the flux conducting bars 9a, 9b, 9c of the stator arrangement 2.

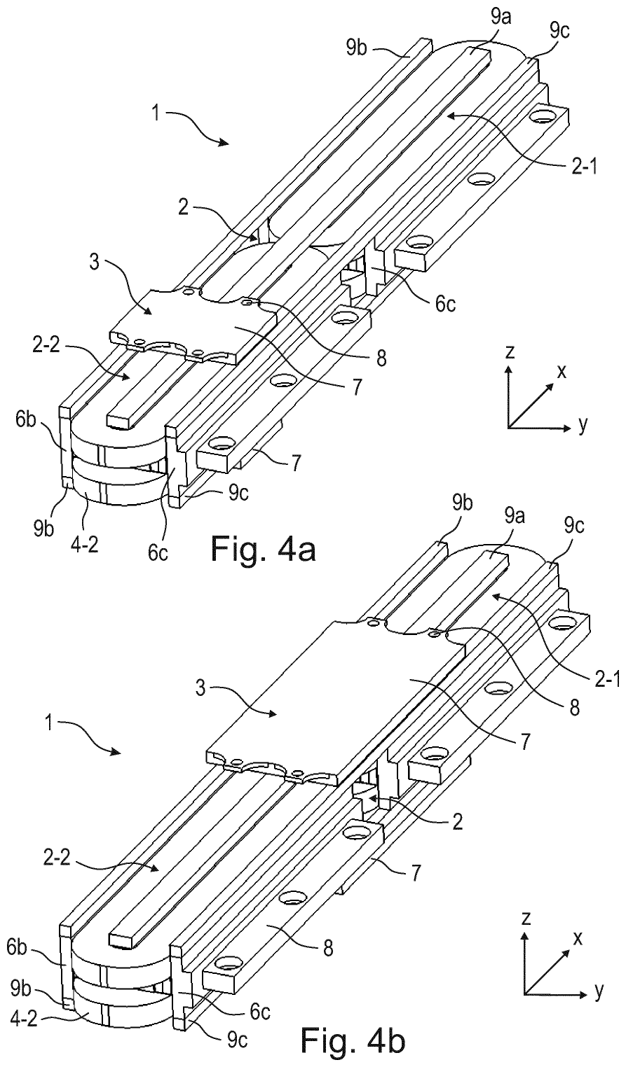

The magnetic bearing device 1 according to the present invention as shown in FIG. 4A with the stator arrangement shown in FIG. 3 and described above, having at least two stators 2-1, 2-2 and a rotor 3, makes possible a movement of the rotor, by means of the integrally configured flux conducting bars 9a, 9b, 9c, which extend along the at least two stators 2-1, 2-2 of the stator arrangement 2 and which connect individual flux conducting components 6a, 6b, 6c of the two stators 2-1, 2-2 with each other, across the boundaries of the two stators 2-1, 2-2 of the coil apparatus 4, without exhibiting larger cogging forces or cogging moments during a transfer of the rotor 3 from one stator 2-1 to the other stator 2-2 and thereby also avoiding force holes in the supporting direction of the rotor 3.

A second embodiment of such a magnetic bearing device 1 with the stator arrangement 2 of FIG. 3 is shown in FIG. 4B. In this embodiment, the rotor flux conducting components 7 of the rotor 3 extend in the x-direction over a much greater length range of the stators 2-1, 2-2 in the x-direction. This allows a more uniform movement in the x-direction during the transition between the two stators 2-1, 2-2, but reduces the possible travel distance of the slider 3.

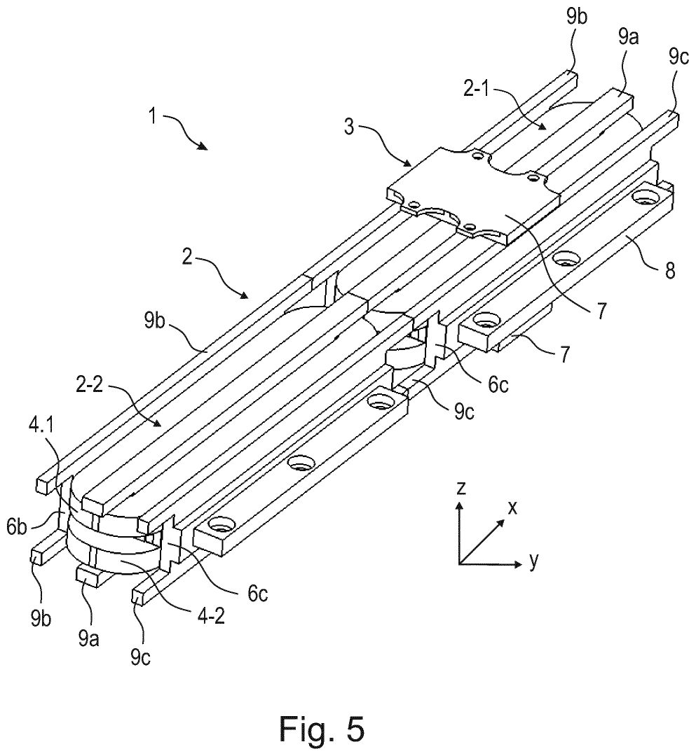

FIG. 5 describes a further embodiment of the magnetic bearing device 1 of FIG. 4A with a different stator arrangement 2. The at least two stators 2-1, 2-2 of this stator arrangement 2 have flux conducting devices 6 separate from one another. In such flux conducting device 6, the flux conducting bars 9a, 9b, 9c each extend only over the length of the individual stators 2-1, 2-2, and may be configured integrally with the flux conducting components 6a, 6b, 6c or separately therefrom. As can be seen clearly in FIG. 5, the individual flux conducting bars 9a, 9b, 9c of the separate flux conducting devices 6 of the individual stators 2-1, 2 2 are in contact with each other or are only very slightly spaced apart from each other, in order to enable the most uniform magnetic flux possible along the entire stator arrangement 2 with only minor interruptions.

Another stator arrangement 2 for a magnetic bearing device 1 according to the invention is shown in FIG. 6A. In contrast to the stator arrangement 2 with two stators 2-1, 2-2 shown in FIG. 3, five stators 2-1, 2-2 are provided here. Other arrangements with three or four, or with more than five stators 2-1, 2-2 are also possible. The flux conducting bars 9a, 9b, 9c configured in one piece extend along the entire length of the stator arrangement 2 and connect the individual flux conducting components 6a, 6b, 6c of the stators 2-1, 2-2 to one another. In contrast to the stators 2-1, 2-2 shown in FIG. 3, the stators 2-1, 2-2 of FIG. 6A are shorter in the x-direction and can thus be combined with one another comparatively easily to form stator assemblies 2 of different lengths. In addition, the subdivision into several shorter stators enables a more significant reduction in power dissipation.

FIG. 6B shows a magnetic bearing device 1 according to the present invention with the stator arrangement 2 of FIG. 6A and a rotor 3 which in the x-direction is longer than a single stator 2 1, 2-2 in the x-direction and thus always extends over more than one stator 2-1, 2-2 in the x-direction.

FIG. 6C shows a further embodiment of a magnetic bearing device 1 according to the present invention. In contrast to the stator assemblies 2 shown in FIGS. 6A and 6B with a plurality of similar stators 2-1, 2-2 arranged in series with short flux conducting components 6a, 6b, 6c, the stators 2-1, 2-2 in FIG. 6C have long flux conducting components 6b, 6c each extending in the x-direction over the entire length of the stators 2-1, 2-2 so that the outer flux conducting components 6b, 6c contact each other at the transition between two stators 2-1, 2-2, so that the flux conducting device 6 is not only connected via the flux conducting bars 9b, 9c extending integrally along the entire stator arrangement 2. The flux conducting components 6a of the embodiment according to FIG. 6C are shorter than the flux conducting components 6b and 6c and do not contact each other. However, it is conceivable that the flux conducting components 6a are designed such, that adjacent or neighboring flux conducting components 6a contact with each other.

FIGS. 7A to 7C show various embodiments of stators 2-1, 2-2 of the magnetic bearing device 1 of FIG. 6C. As can be seen in the partially cut-away view of the stator arrangement 2 in FIG. 7A, in this embodiment the magnets 5 extend in the x-direction parallel to the central flux conducting components 6a arranged in the openings of the coil former 4-1, 4-2 and end in the x-direction at a clear distance from the magnets 5 of the adjacent stators 2-2. In the embodiment of the stator arrangement 2 shown in FIG. 7B, the magnets 5 of the stators 2-1, 2-2 also extend parallel and of equal length to the central flux conducting component 6a, but these magnets 5 are not configured in one piece, but are configured in pieces in the x-direction. FIG. 7C shows another stator arrangement 2 with magnets 5 configured in one piece in the x-direction, wherein these magnets 5 extend in the x-direction to the magnet 5 of the adjacent stators 2-2.

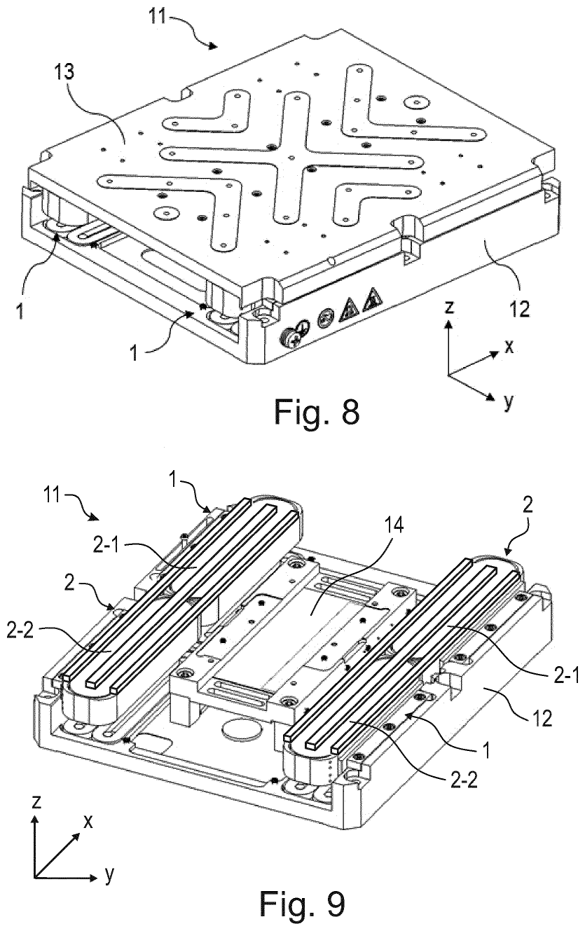

FIGS. 8 to 10 show a positioning system 11 comprising two magnetic bearing assemblies 1 with at least two stators 2-1, 2-2 according to the embodiments described above, and optionally magnetic y-guides allowing guidance perpendicular to the direction of movement of the sliders 3 in the y-direction, a housing 12, a platform 13 and a linear motor 14. Instead of magnetic y-guides, mechanical guides or air bearings could also be used in the y-direction. As shown in FIG. 9, the housing 12 is configured as a rectangular housing plate, the plate having vertical housing walls on two opposite sides. On the inner side of the housing walls, the at least two stators 2-1, 2-2 of the stator arrangement 2 of a magnetic bearing device 1 according to the invention are arranged in series. Thereby, outer flux conducting components 6c of the stators 2-1, 2-2 may be fixed to the corresponding housing wall by means of coupling sections 8. The coil apparatus of a linear motor 14 is arranged in the center of the housing plate.

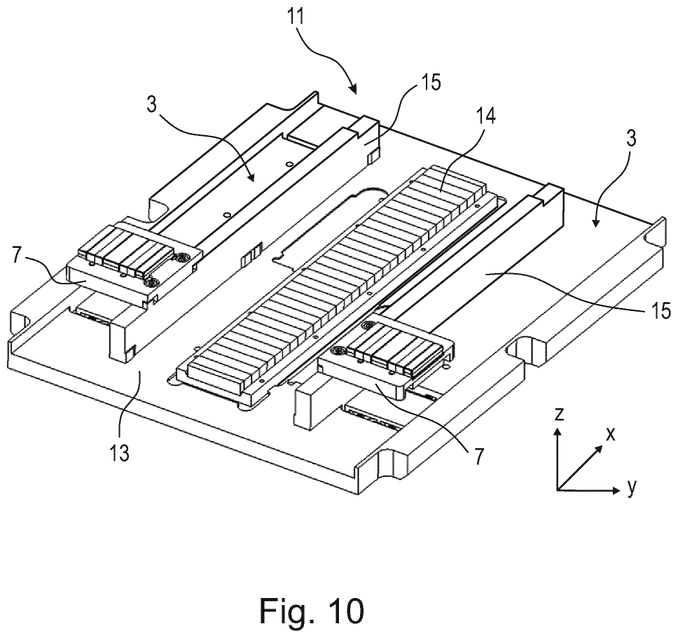

The platform 13 is coupled to a rotor 3 of each of the two magnetic bearing assemblies 1. As shown in FIG. 10, the platform 13 is thereby coupled to both the lower rotor flux conducting component 7 and the upper rotor flux conducting component 7 of the two rotors 3. Coupling to the two upper rotor flux conducting components 7 is made via corresponding recesses in the platform 13, while coupling to the lower rotor flux conducting components 7 is made via two connecting webs 15 arranged on the underside of the platform 13. Each connecting web 15 connects the platform 13 to the lower rotor flux conducting components 7. Furthermore, the rotor part of the linear motor 14 is arranged in the center of the platform 13.

With the positioning system 11 described above, positioning of the platform 13 can be realized without a mechanical friction loss, i.e. without influence of external friction. Furthermore, a highly precise positioning of the platform 13 can be achieved by selecting appropriate control parameters. Thereby, the number of magnetic bearing assemblies 1 in the positioning system 11 is not limited to two magnetic bearing assemblies 1 and further not limited to two stators 2-1, 2-2 for each magnetic bearing device 1, but may be adapted according to the application and installation situation.

1-14. (canceled)

15. A magnetic bearing device comprising:
a stator arrangement having at least two stators and a rotor,
wherein each stator comprises a coil apparatus with at least one coil former, magnets and a flux conducting device,
the rotor is movable relative to the stator arrangement at least along a longitudinal direction of the stator arrangement, and
the stator arrangement and the rotor are configured such that, when electrical energy is applied to the coil apparatus, a magnetic force is applied to the rotor to form an air gap between the stator arrangement and the rotor,
the flux conducting device of each of the at least two stators comprising flux conducting components and flux conducting bars, the flux conducting bars being arranged on the flux conducting components and being at least partially arranged opposite to upper and lower end surfaces of the coil apparatuses of the at least two stators, respectively, and
wherein a smallest distance between the flux conducting bars in the longitudinal direction of the stator arrangement is in a range between zero and a distance between the coil apparatuses of the at least two stators.

16. The magnetic bearing device according to claim 15,
wherein the flux conducting bars of the flux conducting devices of the at least two stators are in contact with each other in the longitudinal direction of the stator arrangement or are in direct contact with each other.

17. The magnetic bearing device according to claim 15,
wherein at least a part of each of the flux conducting bars is configured integrally with the flux conducting components.

18. The magnetic bearing device according to claim 17,
wherein the flux conducting bars are configured separately from the flux conducting components and are in contact with the flux conducting components.

19. The magnetic bearing device according to claim 18,
wherein the flux conducting bars extend in one piece over at least two stators.

20. The magnetic bearing device according to claim 15,
wherein the rotor comprises at least two flux conducting components arranged on opposite sides of the stator arrangement and interconnected by an at least partial non-magnetic element.

21. The magnetic bearing device according to claim 20,
wherein the at least two flux conducting components of the rotor extend in the longitudinal direction of the stator arrangement over at least one of the at least two stators of the stator arrangement.

22. The magnetic bearing device according to claim 20,
wherein the at least two flux conducting components of the rotor are shorter in the longitudinal direction of the stator arrangement than at least one of the two stators of the stator arrangement.

23. The magnetic bearing device according to claim 15,
wherein each of the magnets in each of the at least two stators of the stator arrangement are arranged between two flux conducting components of the flux conducting device.

24. The magnetic bearing device according to claim 15,
wherein each of the coil apparatuses has a coil former arranged one above another and the magnets are arranged in a plane between the coil formers.

25. The magnetic bearing device according to claim 15,
wherein each coil former is arranged between two parallel flux conducting components of the flux conducting device, and extend in the longitudinal direction of the stator arrangement.

26. The magnetic bearing device according to claim 15,
wherein the flux conducting device in each of the at least two stators of the stator arrangement comprises a central flux conducting component having a cross-shaped cross-section, wherein opposite portions of the central flux conducting component are arranged in the openings of different coil formers.

27. The magnetic bearing device according to claim 15,
wherein the magnets and/or the flux conducting components of the stator arrangement are configured in one piece or in several pieces.

28. A positioning system comprising:
a housing, a platform and at least one magnetic bearing device according to claim 15,
wherein the stator arrangement is coupled to the housing and the platform is coupled to the rotor.

29. The magnetic bearing device according to claim 15,
wherein the smallest distance between the flux conducting bars in the longitudinal direction of the stator arrangement is in a range between zero and 50% of the distance of the coil apparatuses of the at least two stators.

30. The magnetic bearing device according to claim 15,
wherein the smallest distance between the flux conducting bars in the longitudinal direction of the stator arrangement is in a range between zero and 10% of the distance of the coil apparatuses of the at least two stators.

31. The magnetic bearing device according to claim 25,
wherein at least one of the flux conducting components has a coupling portion couplable to a housing.
